(19) United States
(12) Patent Application Publication
(10) Pub. No.: US 2011/0135103 A1
(43) Pub. Date: Jun. 9, 2011

(54) System and Method for Audio Adjustment

(75) Inventors: Chi-Yung Sun, Hsinchu City (TW); Hung-Jen Chao, Zhubei City (TW)

(73) Assignee: NUVOTON TECHNOLOGY CORPORATION, III Hsinchu Science Park (TW)

(21) Appl. No.: 12/944,009

(22) Filed: Nov. 11, 2010

(30) Foreign Application Priority Data
Dec. 9, 2009 (TW) 98142107

(51) Int. Cl. H04R 29/00

(52) U.S. Cl. 381/58

(57) ABSTRACT

A system and a method for audio adjustment are provided. The method includes following steps. A first output audio signal generated from the under-test audio playback device according to a frequency response test signal is received. The first output audio signal is analyzed to generate a set of suggested equalization parameter. A set of equalization parameters are adjusted according to the suggested equalization parameters, and a sound test signal is generated from an original sound signal according to the equalization parameters and output to the under-test audio playback device. A second output audio signal is generated from the under-test audio playback device in response to the sound test signal. Whether the auditory effect of the second output audio signal is close to the original sound signal or matches the user's need is determined. The equalization parameters are adjusted when the auditory effect of the second output audio signal is not close to the original sound signal or the user is not satisfied with the auditory effect.

### RELATED APPLICATIONS

This application claims priority to Taiwan Application Serial Number 98142107, filed Dec. 9, 2009, which is herein incorporated by reference.

### BACKGROUND

1. Field of Invention

The present invention relates to an electronic system and a method for processing digital data. More particularly, the present invention relates to a system and a method for audio adjustment.

2. Description of Related Art

In modern technology, various devices or toys are respectively equipped with speech signal playback devices to deliver speech signals or music to the users. The speech signal can act as an instruction to guide the user and the music can amuse the children when they play with the toy. During the design process of these devices or toys, it is necessary to download/burn the sample sound signal to the signal processing chip such that the under-test playback device, i.e. amplifier, generates a sound signal according to the sample sound signal. If the user is not satisfied with the auditory effect, the user has to modified the sample sound signal and repeats the above procedure again and again until the auditory effect matches the user's need. There is no basic sample sound signal for reference in the above method, and it is time-consuming if only trial and error is used.

Thus, what is needed is a method and a system for audio adjustment to overcome the above issues. The present disclosure addresses such a need.

### SUMMARY

An aspect of the present disclosure provides a method for audio adjustment adapted in an audio adjustment system. The method comprises the steps of: outputting a frequency response test signal to an under-test audio playback device; receiving a first output audio signal generated from the under-test audio playback device according to the frequency response test signal; generating a set of suggested equalization parameters by performing a frequency response analysis on the first output audio signal; adjusting a set of equalization parameters according to the suggested equalization parameters to generate a sound test signal from an original sound signal according to the equalization parameters and output the sound test signal to the under-test audio playback device; generating a second output audio signal from the under-test audio playback device in response to the sound test signal instantly; determining whether the auditory effect of the second output audio signal is close to the original sound signal or matches the user's need; and adjusting the equalization parameters when the auditory effect of the second output audio signal is not close to the original sound signal or the user is not satisfied with the auditory effect.

Another aspect of the present disclosure provides an audio adjustment system. The audio adjustment system comprises a first sound test module, an under-test audio playback device, an analysis module, an equalizer and a second sound test module. The first sound test module generates a frequency response test signal. The under-test audio playback device receives the frequency response test signal to further generate a first output audio signal and to receive a sound test signal to further generate a second output audio signal. The analysis module receives the first output audio signal and to perform a frequency response analysis on the first output audio signal to further generate a set of suggested equalization parameters. The equalizer provides an adjusting interface to a user to adjust a set of equalization parameters. The second sound test module receives an original sound signal and output the sound test signal according to the set of equalization parameters. The user adjusts the equalization parameters according to the suggested equalization parameters and the second output audio signal such that an auditory effect of the second output audio signal is close to the original sound signal or matches the user's need.

Yet another aspect of the present disclosure provides an audio adjustment system. The audio adjustment system comprises a host, an under-test audio playback device and a sound-receiving device. The host includes a first sound test module, an analysis module, an equalizer and a second sound test module. The first sound test module generates a frequency response test signal. The analysis module performs a frequency response analysis to further generate a set of suggested equalization parameters. The equalizer provides an adjusting interface to a user to adjust a set of equalization parameters. The second sound test module receives an original sound signal and output the sound test signal according to the set of equalization parameters. The under-test audio playback device receives the frequency response test signal to further generate a first output audio signal and to receive a sound test signal to further generate a second output audio signal. The sound-receiving device receives the first output audio signal and to send the first output audio signal to the host. The analysis module performs the frequency response analysis on the first output audio signal, the user adjusts the equalizer parameters according to the suggested equalizer parameters and the second output audio signal to further make a auditory effect of the second sound signal close to the original sound signal or match the user's need.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a diagram of an audio adjustment system of an embodiment of the present disclosure; and

FIG. 2 is a flow chart of a method for audio adjustment of an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

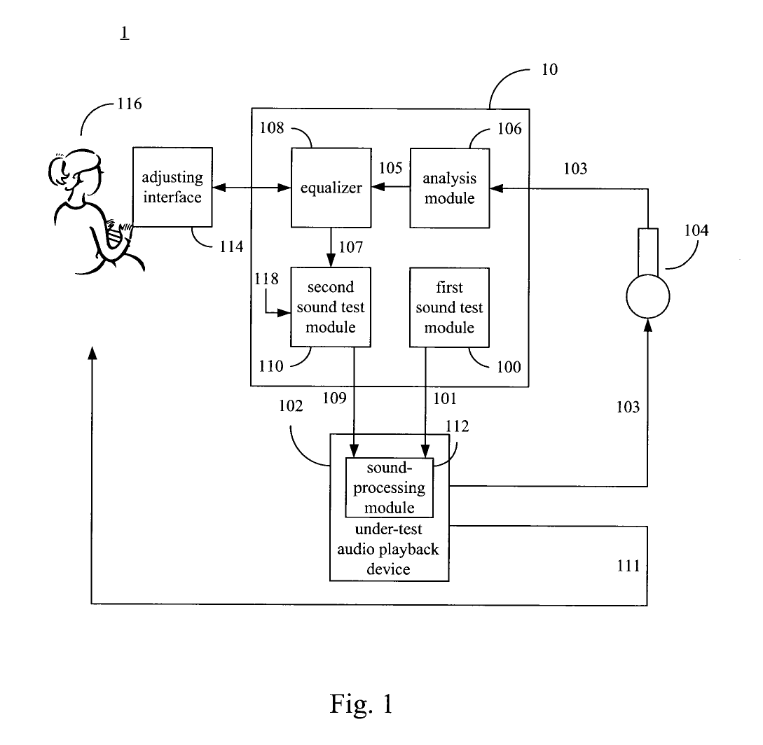

FIG. 1 is a diagram of an audio adjustment system 1 of an embodiment of the present disclosure. The audio adjustment system 1 includes a first sound test module 100, an under-test audio playback device 102, a sound-receiving device 104, an analysis module 106, an equalizer 108 and a second sound test module 110.

The first sound test module 100, the analysis module 106, the equalizer 108 and the second sound test module 110 can be implemented by software, hardware, firmware or a combination thereof. In an embodiment, the first sound test module 100, the analysis module 106, the equalizer 108 and the second sound test module 110 are substantially operated by an application program stored in a host 10 to perform a method for sound adjustment.

The first sound test module 100 generates a frequency response test signal 101. In an embodiment, the frequency response test signal 101 is a chirp signal. The chirp signal is a signal that gradually transits from low frequency to high frequency. The under-test audio playback device 102 in an embodiment further includes a sound-processing module 112. The sound-processing module 112 performs a digital to analog conversion, an encoding process, a compression process and a re-sampling process on the frequency response test signal 101 such that the under-test audio playback device 102 is able to play the processed frequency response test signal 101. The sound-processing module 112 substantially includes a digital transmission interface (not shown) to receive the frequency response test signal 101 to further output the frequency response test signal 101 to the under-test audio playback device 102. In an embodiment, the digital transmission interface is a universal serial bus (USB). The under-test audio playback device 102 plays the processed frequency response test signal 101 through an amplifier (not shown) to generate a first output audio signal 103.

The analysis module 106 receives the first output audio signal 103 through the sound-receiving device 104 connected to the host 10. In an embodiment, the sound-receiving device 104 is a microphone or a composite device combining a microphone and a sound signal-processing chip to perform an analog to digital conversion on the first output audio signal 103. After receiving the first output audio signal 103, the analysis module 106 performs a frequency response analysis on the first output audio signal 103 to further generate a set of suggested equalization parameters 105.

In an embodiment, the analysis module 106 performs a frequency response analysis on a plurality of frequency bands of the first output audio signal 103 respectively. For example, the analysis module 106 is able to perform a band-pass process on the frequency bands of the first output audio signal 103. Due to the characteristic of the frequency response test signal 101, which is a gradual transition from low frequency to high frequency, the playback result of each frequency band is obtained from the first output audio signal 103. The analysis module 106 further determines the amplitude differences between each two of the frequency bands to generate suggested equalization parameters 105 according to the amplitude differences. Each of the suggested equalization parameter can correspond to a frequency band.

For example, in an embodiment, since the amplitude differences of each two of the frequency bands are known, the suggested equalization parameters 105 can make the amplitudes of each of the frequency bands of the first output audio signal 103 generated by the under-test audio playback device 102 through the amplifier with the adjustment of the suggested equalization parameters 105 the same. In other words, a curve of the amplitudes of the frequency bands of the first output audio signal 103 can become smooth.

The equalizer 108 provides an adjusting interface 114 to a user 116 to adjust a set of equalization parameters 107. The adjusting interface 114 can be a combination of a display screen of the host 10 to show the adjusting condition of each frequency band, and an input device such as a keyboard or a mouse for the user 116 to adjust the equalization parameters 107 corresponding to the frequency bands.

The user 116 can adjust each frequency band of the equalization parameters 107 according to the suggested equalization parameters 105 such that the second sound test module 110 converts the original sound signal 118 to the sound test signal 109 according to the equalization parameters 107. The original sound signal 118 is generated by a sound source (not shown). The original sound signal 118 in the present embodiment can be a music signal or a speech signal and sound test signal 109 in the present embodiment can be a music signal or a speech signal as well. Similarly, the sound-processing module 112 is able to transmit the sound test signal 109 to the under-test audio playback device 102 through the digital transmission interface. After the processing and playback of the under-test audio playback device 102, a second output audio signal 111 is generated.

After the equalization parameters 107 are adjusted according to the suggested equalization parameters 105, the spectrum of the second output audio signal 111 is substantially close to the original sound signal 118. However, some detail adjustments are still needed to make the music or speech signal approaches the auditory effect of human's ear, wherein the adjustments depend on the different types of the audio signal. For example, some music needs more low frequency and doesn't need too much high frequency. Therefore, the user 116 can adjust the sound test signal 109 in the host 10 according to the suggested equalization parameters 105 until the spectrum of the second output audio signal 111 played by the under-test audio playback device 102 is the same as the sound test signal 109 first, then further adjust the equalization parameters 107 according to the auditory effect of the second output audio signal 111 through the adjusting interface 114 in a real time manner until the auditory effect of the second output audio signal 111 is close to the original sound signal 118 or matches the user's need.

Through the audio adjustment system described above, the user can take the suggested equalization parameters 105 as a reference to adjust the equalization parameters 107 through the adjusting interface 114. If the auditory effect doesn't exactly match the user's need, the equalization parameters can be further fine-tuned such that a better result is obtained. When the user is satisfied with the auditory effect of the second output audio signal 111, the music/speech information of the second output audio signal 111 can be burned to a read only memory (ROM) of the under-test audio playback device 102. The ROM can be a MASK ROM, a flash memory, a dynamic memory, a static memory or a one time programmable ROM (OTPROM). Through the audio adjustment system described above, the music/speech information stored in the under-test audio playback device 102 is able to match the user's need.

Please refer to FIG. 1 again. In another embodiment of the present disclosure, the sound-processing module 112 can be separated from and placed outside of the under-test audio playback device 102. The sound-processing module 112 has an interface, such as a USB, connected to the host 10 to receive the frequency response test signal 101 and the second output audio signal 109 from the first sound test module 100 and the second sound test module 110 respectively to perform the digital to analog conversion, the encoding process, the compression process and the re-sampling process. Most of the playback devices on the market store the speech/music information by burning them into the ROM such as a MASK ROM. Therefore, there is no need to have an interface for the connection to the host (such as USB). The USB interface of the sound-processing module 112 under such circumstance is unnecessary. Therefore, the sound-processing module 112 can be placed outside the under-test audio playback device 102 to provide audio adjustment purpose only to reduce the manufacturing cost of the audio playback device.

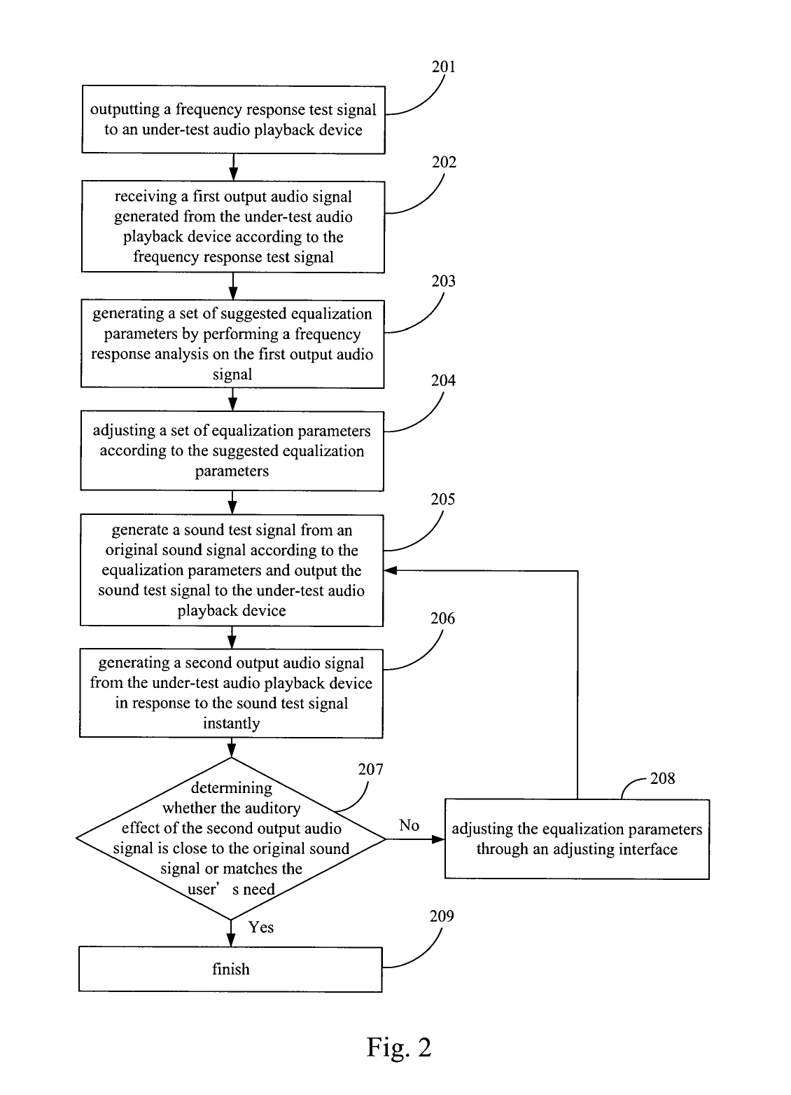

Please refer to FIG. 2. FIG. 2 is a flow chart of a method for audio adjustment of an embodiment of the present disclosure. The method is adapted in the audio adjustment system 1 depicted in FIG. 1. The method described herein can be implemented by hardware, software, firmware or a combination thereof. In one embodiment, the method of the present embodiment can be implemented by an application program, wherein the application program is able to control the modules of the audio adjustment system 1. The application program is stored in a computer readable medium such as a ROM, a flash, a floppy disk, a hard disk, a compact disc, a portable storage, a database or other medium used by those skilled in the art.

The method comprises the steps as depicted in FIG. 2. (It's noticed that the order of the steps in the present embodiment can be adjusted according to various conditions. Also, some of the steps in the present embodiment can be performed simultaneously according to various conditions as well.)

Please refer to both FIG. 1 and FIG. 2, in step 201, the first sound test module 100 outputs the frequency response test signal 101 to the under-test audio playback device 102, wherein the frequency response test signal 101 may be processed by the sound-processing module 112 of the under-test audio playback device 102.

In step 202, the analysis module 106 receives the first output audio signal 103 generated from the under-test audio playback device 102 according to the frequency response test signal 101. In an embodiment, the analysis module 106 receives the first output audio signal 103 after the reception and processing of the sound-receiving device 104.

In step 203, the analysis module 106 performs the frequency response analysis on the first output audio signal 103 to generate set of suggested equalization parameters 105. In an embodiment, the analysis module 106 is able to perform a band-pass process on a plurality of frequency bands of the first output audio signal 103 respectively. Due to the characteristic of the frequency response test signal 101, which is a gradual transition from low frequency to high frequency, the playback result of each frequency bands is obtained from the first output audio signal 103. The analysis module 106 further determines the amplitude differences between each two of the frequency bands to generate suggested equalization parameters 105 according to the amplitude differences. Each of the suggested equalization parameter corresponds to a frequency band.

In step 204, a set of equalization parameters 107 are adjusted according to the suggested equalization parameters 105 through a adjusting interface 114 provided by the equalizer 108. Then in step 205, a sound test signal 109 is generated from an original sound signal 118 according to the equalization parameters 107 and the sound test signal 109 is outputted to the under-test audio playback device 102. The original sound signal 118/sound test signal 109 in the present embodiment can be either a music or a speech signal. Then in step 206, the second output audio signal 111 is generated according to the sound test signal 109 from the under-test audio play back device 102 instantly.

In step 207, whether the auditory effect of the second output audio signal 111 is close to the original sound signal 118 or matches the user's need is determined. When the auditory effect of the second output audio signal 111 is not close to the original sound signal 118 or the user is not satisfied with the auditory effect, the step 208 is performed to adjust the equalization parameters 107 through the adjusting interface 114. Then the step 205 is performed again. When the auditory effect of the second output audio signal 111 is close to the original sound signal 118 or the user is satisfied with the auditory effect, the step 209 is performed to finish the flow.

The advantage of the present disclosure provides a system and a method for audio adjustment according to a set of suggested equalization parameters generated from the frequency response test signal to make the frequency response of the output audio signal approaches the sound test signal quickly first, then a fine-tune mechanism is provided to make further adjustment according to the characteristic of the sound test signal. Therefore, the auditory effect of the output signal is quickly adjusted to match the sound test signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for audio adjustment adapted in an audio adjustment system, wherein the method comprises the steps of:
outputting a frequency response test signal to an under-test audio playback device;
receiving a first output audio signal generated from the under-test audio playback device according to the frequency response test signal;
generating a set of suggested equalization parameters by performing a frequency response analysis on the first output audio signal;
adjusting a set of equalization parameters according to the suggested equalization parameters to generate a sound test signal from an original sound signal according to the equalization parameters and output the sound test signal to the under-test audio playback device;
generating a second output audio signal from the under-test audio playback device in response to the sound test signal instantly;
determining whether the auditory effect of the second output audio signal is close to the original sound signal or matches the user's need; and
adjusting the equalization parameters when the auditory effect of the second output audio signal is not close to the original sound signal or the user is not satisfied with the auditory effect.

2. The method of claim 1, wherein the step of outputting the frequency response test signal to the under-test audio playback device further comprises the steps of:
outputting the frequency response test signal from a host through a digital transmission interface to the under-test audio playback device.

3. The method of claim 1, wherein the frequency analysis further comprises the steps of:
performing an analog to digital conversion on the first output audio signal;
performing a frequency response analysis on a plurality of frequency bands of the first output audio signal respectively;
determining amplitude differences between each two of the frequency bands; and
generating the suggested equalization parameters according to the amplitude differences.

4. The method of claim 1, wherein the step of adjusting the equalization parameters according to the suggested equalization parameters is to make the frequency spectrum of the second output audio signal close to the frequency spectrum of the original sound signal or to make the user satisfy with the auditory effect of the second output audio signal.

5. The method of claim 1, wherein the frequency response test signal is a chirp signal.

6. The method of claim 1, wherein the original sound signal is a speech signal or a music signal and the sound test signal is a speech signal or a music signal.

7. A audio adjustment system comprising:
a first sound test module to generate a frequency response test signal;
an under-test audio playback device to receive the frequency response test signal to further generate a first output audio signal and to receive a sound test signal to further generate a second output audio signal;
an analysis module to receive the first output audio signal and to perform a frequency response analysis on the first output audio signal to further generate a set of suggested equalization parameters;
an equalizer to provide an adjusting interface to a user to adjust a set of equalization parameters; and
a second sound test module to receive an original sound signal and output the sound test signal according to the set of equalization parameters;
wherein the user adjusts the equalization parameters according to the suggested equalization parameters and the second output audio signal such that an auditory effect of the second output audio signal is close to the original sound signal or matches the user's need.

8. The audio adjustment system of claim 7, further comprising a sound-processing module having a digital transmission interface to receive the frequency response test signal and the sound test signal to further output to the under-test audio playback device.

9. The audio adjustment system of claim 8, wherein the sound-processing module is further to perform an encoding process, a compression process and a re-sampling process on the frequency response test signal and the sound test signal.

10. The audio adjustment system of claim 7, further comprising a sound-receiving device, wherein the analysis module receives the first output audio signal through the sound-receiving device.

11. The audio adjustment system of claim 10, wherein the sound-receiving device further performs an analog to digital conversion on the first output audio signal.

12. The audio adjustment system of claim 7, wherein the analysis module performs the frequency response analysis on a plurality of frequency bands of the first output audio signal respectively and to determine amplitude differences between each two of the frequency bands to generate the suggested equalization parameters according to the amplitude differences.

13. The audio adjustment system of claim 7, wherein the equalization parameters are adjusted through the adjusting interface to make the auditory effect of the second output audio signal is close to the original sound signal or match the user's need.

14. The audio adjustment system of claim 7, wherein the frequency response test signal is a chirp signal.

15. The audio adjustment system of claim 7, wherein the original sound signal is a speech signal or a music signal and the sound test signal is a speech signal or a music signal.

16. A audio adjustment system comprising:
a host comprising:
a first sound test module to generate a frequency response test signal;
an analysis module to perform a frequency response analysis to further generate a set of suggested equalization parameters;
an equalizer to provide an adjusting interface to a user to adjust a set of equalization parameters;
a second sound test module to receive an original sound signal and output the sound test signal according to the set of equalization parameters;
an under-test audio playback device to receive the frequency response test signal to further generate a first output audio signal and to receive a sound test signal to further generate a second output audio signal; and
a sound-receiving device to receive the first output audio signal and to send the first output audio signal to the host;
wherein the analysis module performs the frequency response analysis on the first output audio signal, the user adjusts the equalizer parameters according to the suggested equalizer parameters and the second output audio signal to further make a auditory effect of the second sound signal close to the original sound signal or match the user's need.

17. The audio adjustment system of claim 16, further comprising a sound-processing module having a digital transmission interface to receive the frequency response test signal and the sound test signal to further output to the under-test audio playback device.

18. The audio adjustment system of claim 16, wherein the analysis module performs the frequency response analysis on a plurality of frequency bands of the first output audio signal respectively and to determine amplitude differences between each two of the frequency bands to generate the suggested equalization parameters according to the amplitude differences.
